(19) United States
(12) Patent Application Publication
(10) Pub. No.: US 2016/0185887 A1
(43) Pub. Date: Jun. 30, 2016

(54) POLYMERIZABLE COMPOSITION FOR HIGH-REFRACTIVE OPTICAL MATERIAL AND METHOD FOR PREPARING HIGH-REFRACTIVE OPTICAL MATERIAL

(71) Applicant: KOC SOLUTION CO., LTD., Daejeon (KR)

(72) Inventors: Dong Gyu JANG, Daejeon (KR); Soo Gyun Roh, Daejeon (KR); Jong Hyo Kim, Daejeon (KR)

(21) Appl. No.: 14/909,594

(22) PCT Filed: Aug. 8, 2014
(86) PCT No.: PCT/KR2014/007389

§ 371 Date: Feb. 2, 2016

(30) Foreign Application Priority Data
Aug. 8, 2013 (KR) 10-2013-0094370

(51) Int. Cl. C08F 220/30; G02B 5/23; G02B 5/22; G02B 1/04

(52) U.S. Cl. CPC C08F 220/30; G02B 1/041; G02B 5/23; G02B 5/223; C08F 2220/301

(57) ABSTRACT

The present invention relates to a novel polymerizable composition for an optical material with a high refractive index and a method of preparing the optical material. More particularly, the present invention provides a polymerizable composition for an optical material with a high refractive index, including a compound represented by Formula 1 or 2 and a compound represented by Formula 3 and an optical material, particularly a glass lens, with a high refractive index obtained through polymerization of the polymerizable composition. In addition, the present invention provides a polymerizable composition for a photochromic optical material with a high refractive index composition and a photochromic optical material, particularly a photochromic glass lens, with a high refractive index obtained through polymerization of the polymerizable composition.

### TECHNICAL FIELD

The present invention relates to a polymerizable composition for an optical material with a high refractive index and a method of preparing the optical material.

### BACKGROUND ART

Korean Patent Nos. 10-0496911, 10-0498896, etc. disclose a composition for acrylic optical materials having a high Abbe number and superior optical characteristics, such as superior transparency, light weight, and thermal resistance, as well as a high refractive index. However, since an acrylic monomer has high adhesion, demolding properties are decreased when lenses are manufactured through cast polymerization using the acrylic monomer. When lenses with a high refractive index are manufactured using the acrylic monomer, a substituent is substituted with Br in some cases. In this case, adhesion is far increased. Such an acrylic monomer substituted with Br has a high refractive index, but yellows at high temperature.

The term “photochromism” means a phenomenon that a substance is usually transparent and, when exposed to UV rays, the substance exhibits a specific color. A material causing such photochromism is called a photochromic compound (or reversible photochromic compound). When the photochromic compound is applied to glass lenses, photochromic lenses having a characteristic that color is different before and after light irradiation can be manufactured. Photochromic lenses are manufactured by preparing a photochromic polymerizable composition through mixing of a photochromic compound with a general polymerizable monomer compound and hardening the photochromic polymerizable composition. Existing photochromic lenses can have satisfactory color changeability and optical characteristics under middle refraction, but lifespan of color changeability thereof under high refraction is very short. Accordingly, when existing photochromic lenses are commercialized, thermal resistance and mechanical characteristics are poor and lifespan thereof is short. Therefore, there are problems in commercializing the photochromic lenses.

### RELATED DOCUMENTS

### Patent Documents

### (Patent Document 1) Korean Patent No. 10-0496911

### (Patent Document 2) Korean Patent No. 10-0498896

### (Patent Document 3) Korean Patent Laid-Open Publication No. 10-2008-0045267

### (Patent Document 4) Korean Patent Laid-Open Publication No. 10-2005-0026650

### SUMMARY OF THE INVENTION

### Technical Problem

Therefore, the present invention has been made in view of the above problems, and it is an object of the present invention to provide a new polymerizable composition for an acrylic optical material with a high refractive index and a method of preparing the acrylic optical material, more particularly a polymerizable composition for a glass lens with a high refractive index and a method of manufacturing the glass lens.

It is another object of the present invention to provide a polymerizable composition for an optical material having superior photochromic performance and optical characteristics as well as a high refractive index, and a method of preparing the photochromic optical material with a high refractive index, more particularly a method of producing a polymerizable composition for a glass lens and a photochromic glass lens with a high refractive index.

### Technical Solution

In accordance with an aspect of the present invention, the above and other objects can be accomplished by the provision of a polymerizable composition for an optical material with a high refractive index including (a) a compound represented by Formula 1 or 2 below and

(b) a compound represented by Formula 3 below. This polymerizable composition may further include one or more compounds selected from a compound represented by Formula 4 below, a compound represented by Formula 5 below, a compound represented by Formula 6 below, and other acrylic monomers:

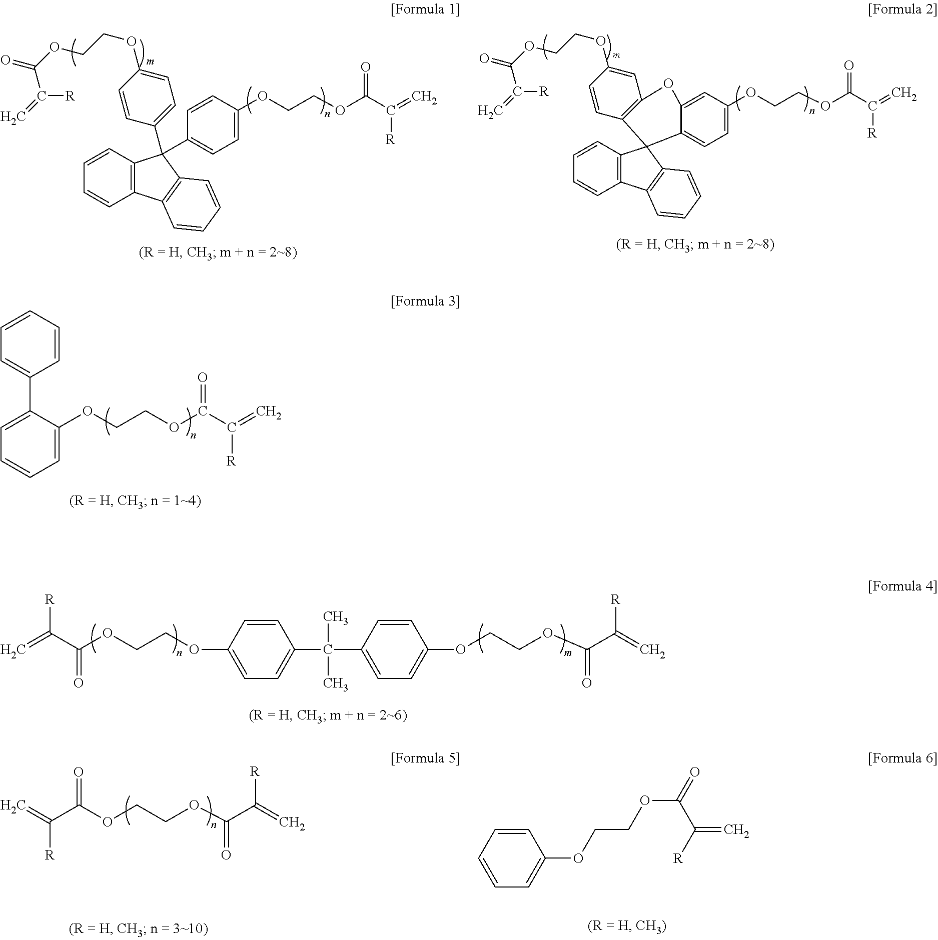

In accordance with another aspect of the present invention, there is provided a polymerizable composition for an optical material with a high refractive index including (a) a compound represented by Formula 1 or 2 below,

(b) a compound represented by Formula 3 below, and

(c) a photochromic compound. This photochromic polymerizable composition may further include one or more compounds selected from the compound represented by Formula 4, a compound represented by Formula 5 below, a compound represented by Formula 6 below, and other acrylic monomers.

In accordance with another aspect of the present invention, there are provided a method of preparing a fluorene-containing acrylic optical material with a high refractive index, including cast-polymerizing the polymerizable composition for an optical material with a high refractive index, and a fluorene-containing acrylic optical material with a high refractive index obtained by cast-polymerizing the polymerizable composition.

In accordance with yet another aspect of the present invention, there are provided a method of preparing a fluorine-containing acrylic photochromic optical material with a high refractive index, including cast-polymerizing the polymerizable composition for a photochromic optical material with a high refractive index, and a fluorine-containing acrylic photochromic optical material with a high refractive index obtained by cast-polymerizing the photochromic polymerizable composition.

The optical material with a high refractive index or the photochromic optical material with a high refractive index includes particularly a glass lens.

### Advantageous Effects

The present invention provides a novel fluorine-containing acrylic optical material with a high refractive index and a novel photochromic optical material with a high refractive index. The optical material with a high refractive index or the photochromic optical material with a high refractive index according to the present invention can be used in manufacturing, particularly, glass lenses, and exhibits superior optical characteristics when applied to optical lenses. In addition, the photochromic optical material with a high refractive index according to the present invention has a high refractive index, and superior color changeability to existing lenses with a medium refractive index.

### DETAILED DESCRIPTION OF PREFERRED EMBODIMENTS

A polymerizable composition for an optical material with a high refractive index according to the present invention includes a compound represented by Formula 1 or 2 below and a compound represented by Formula 3 below. The polymerizable composition of the present invention includes preferably 5 to 40% by weight of the compound represented by Formula 1 or 2 and the 30 to 60% by weight of the compound represented by Formula 3. The polymerizable composition of the present invention may further include one or more compounds selected from the group consisting of a compound represented by Formula 4 below, a compound represented by Formula 5 below, a compound represented by Formula 6 below, and other acrylic monomers. Examples of the other acrylic monomers include diethylene glycol dimethacrylate, triethylene glycol dimethacrylate, tetraethylene glycol dimethacrylate, butanediol dimethacrylate, hexamethylenedimethacrylate, bisphenol A dimethacrylate, 2,2-bis(4-methacryloyloxyethoxy-3,5-dibromophenyl)propane, 2,2-bis-(4-methacryloyloxyethoxy phenyl)propane, 2,2-bis-(4-betaacryloyloxyethoxy phenyl)propane, 2,2-bis-(4-methacryloyloxypentaethoxyphenyl)propane, bis-4-vinyl ether, bis-4-vinyl sulfide, 1,2-(p-vinylbenzyloxy)ethane, 1,2-(p-vinylbenzylthio)ethane, bis-(p-vinylbenzyloxy ethyl)sulfide, 2,2-bis-4-bis-4-vinylbenzyl sulfide, pentaerythritol triacrylate, pentaerythritol tetraacrylate, propoxylated glycerol triacrylate, trimethylolpropane triacrylate, dipentaerythritol hexaacrylate, bisphenol A-diglycidyl ether diacrylate, bisphenol A-diglycidyl ether dimethacrylate, tetrabromo bisphenol A-diglycidyl ether diacrylate, and tetrabromobisphenol A-diglycidyl ether dimethacrylate:

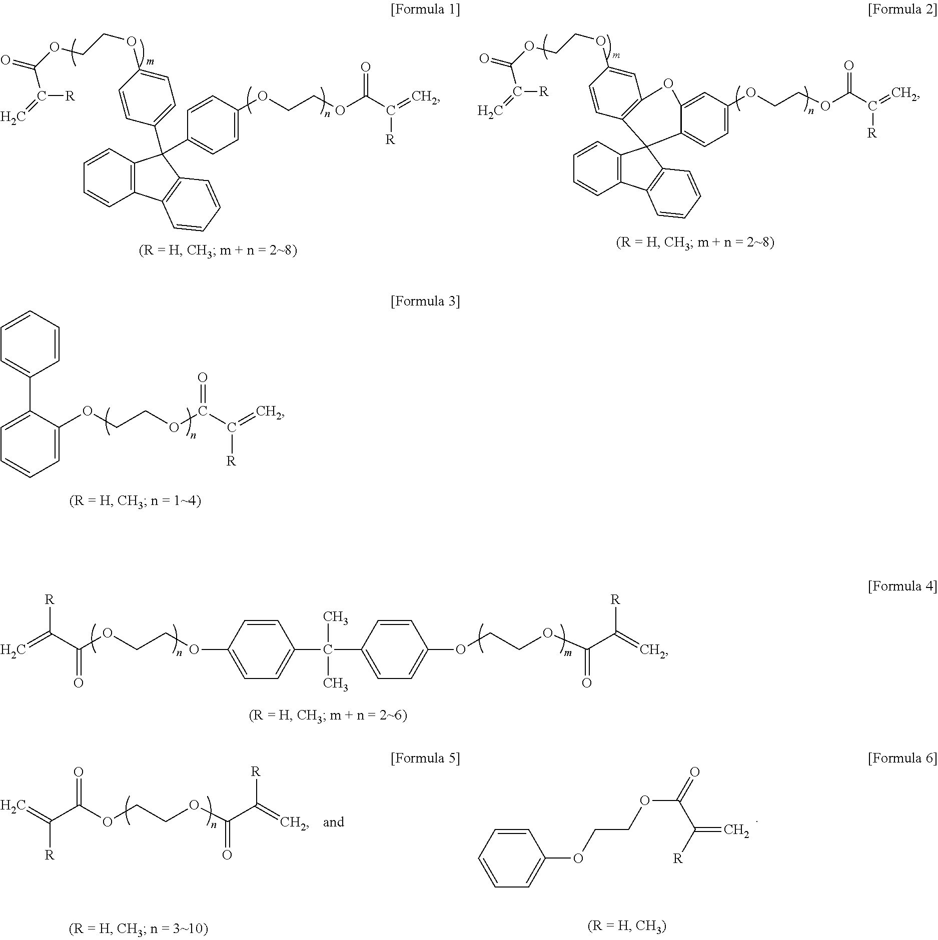

The polymerizable composition of the present invention may further include a compound represented by Formula 7 below:

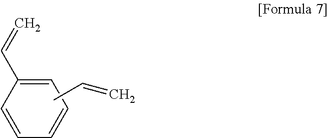

The polymerizable composition of the present invention may further include a reactive diluent. Preferably, the reactive diluent is one or more compounds selected from the group consisting of styrene, divinylbenzene, alpha-methylstyrene, alpha-methyl styrene dimer, benzyl methacrylate, chlorostyrene, bromostyrene, methoxystyrene, monobenzyl maleate, dibenzyl maleate, mono-benzyl fumarate, dibenzyl fumarate, methylbenzyl maleate, dimethyl maleate, diethyl maleate, dibutyl maleate, dibutylfumarate, monobutyl maleate, monopentyl maleate, dipentyl maleate, monopentyl fumarate, dipentylfumarate, and diethylene glycol bis-arylcarbonates.

The polymerizable composition of the present invention may further include one or more of a thermal stabilizer, an internal release agent, an ultraviolet light absorbent, and a polymerization initiator (catalyst).

As the thermal stabilizer, any thermal stabilizers, such as a phosphorous thermal stabilizer, a metal fatty acid salt-based stabilizer, a lead-based stabilizer, and an organic tin-based stabilizer, which are applicable to optical lenses may be used.

When the phosphorous thermal stabilizer is used, yellowing at high temperature, particularly yellowing during secondary polymerization and yellowing during hard-coating or multi-coating, may be suppressed. In addition, yellowing occurring during lens storage may be effectively suppressed. As the phosphorous thermal stabilizer, one or more compounds selected from the group consisting of triphenyl phosphite, diphenyl decyl phosphite, diphenyl isodecyl phosphite, phenyl didecyl phosphite, diphenyl dodecyl phosphite, trinonyl phenyl phosphite, diphenyl isooctyl phosphite, tributyl phosphite, tripropylphosphite, triethylphosphite, trimethylphosphite, tris(monodecyl phosphite), and tris(monophenyl)phosphate are preferred.

As the metal fatty acid salt-based stabilizer, one or more compounds selected from compounds such as calcium stearate, barium stearate, zinc stearate, cadmium stearate, lead stearate, magnesium stearate, aluminum stearate, potassium stearate, and zinc octoate may be used.

As the lead-based thermal stabilizer, one or more compounds selected from compounds such as, for example, 3PbO.PbSO4.4H₂O, 2PbO.Pb(C₈H₄O₄), and 3PbO.Pb(C₄H₂O₄).H₂O may be used.

As the organic tin-based stabilizer, one or more compounds selected from compounds such as, for example, dibutyltin dilaurate, dibutyltin maleate, dibutyltin bis(isooctyl maleate), dioctyltin maleate, dibutyltin bis(monomethyl maleate), dibutyltin bis(lauryl mercaptide), dibutyltin bis(isooxyl mercaptoacetate), monobutyltin tris(isooctyl mercaptoacetate), dimethyltinbis(isooctyl mercaptoacetate), methyltin tris(isooctyl mercaptoacetate), dioctyltinbis(isooctyl mercaptoacetate), dibutyltin bis(2-mercaptoethyl oleate), monobutyltin tris(2-mercaptoethyl oleate), dimethyltin bis(2-mercaptoethyl oleate), and monomethyl tin tris(2-mercaptoethyl oleate) may be used.

The thermal stabilizer may be preferably included in an amount of 0.01 to 5% by weight based on 100% by weight of a composition. When the thermal stabilizer is used in an amount of less than 0.01% by weight, yellowing suppression effects are low. When the thermal stabilizer is used in an amount of greater than 5% by weight, a defective polymerization ratio during hardening is high and thermal stability is decreased.

The polymerizable composition of the present invention may further include an internal release agent. As the internal release agent, any internal release agents usable in optical lenses may be used. For example, a phosphoric ester compound, a silicon-based surfactant, a fluorine-based surfactant, or the like or a mixture of two or more thereof may be used as the internal release agent. For example, polyoxyethylene nonylphenol ether phosphate (in an amount of 5% by weight when 5 mol of ethylene oxide is contained, in an amount of 80% by weight when 4 mol of ethylene oxide is contained, in an amount of 10% by weight when 3 mol of ethylene oxide is contained, or in an amount of 5% by weight when 1 mol of ethylene oxide is contained), polyoxyethylene nonylphenol ether phosphate (in an amount of 3% by weight when 9 mol of ethylene oxide is contained, in an amount of 80% by weight when 8 mol of ethylene oxide is contained, in an amount of 5% by weight when 9 mol of ethylene oxide is contained, in an amount of 6% by weight when 7 mol of ethylene oxide is contained, or in an amount of 6% by weight when 6 mol of ethylene oxide is contained), polyoxyethylene nonylphenol ether phosphate (in an amount of 3% by weight when 13 mol of ethylene oxide is contained, in an amount of 80% by weight when 12 mol of ethylene oxide is contained, in an amount of 8% by weight when 11 mol of ethylene oxide is contained, in an amount of 3% by weight when 9 mol of ethylene oxide is contained, or in an amount of 6% by weight when 4 mol of ethylene oxide is contained), polyoxyethylene nonylphenol ether phosphate (in an amount of 3% by weight when 17 mol of ethylene oxide is contained, in an amount of 79% by weight when 16 mol of ethylene oxide is contained, in an amount of 10% by weight when 15 mol of ethylene oxide is contained, in an amount of 4% by weight when 14 mol of ethylene oxide is contained, or in an amount of 4% by weight when 13 mol of ethylene oxide is contained), polyoxyethylene nonylphenol ether phosphate (in an amount of 5% by weight when 21 mol of ethylene oxide is contained, in an amount of 76% by weight when 20 mol of ethylene oxide is contained, in an amount of 7% by weight when 19 mol of ethylene oxide is contained, in an amount of 6% by weight when 18 mol of ethylene oxide is contained, or in an amount of 4% by weight when 17 mol of ethylene oxide is contained), Zelec UN™, or the like or a mixture of two or more thereof may be used as the phosphoric ester compound. The internal release agent is preferably included in an amount of 0.001 to 10% by weight in 100% by weight of the polymerizable composition.

The polymerizable composition of the present invention may further include an organic dye, an inorganic pigment, an anti-coloring agent, an antioxidant, a light stabilizer, etc., as in general polymerizable compositions.

The polymerizable composition for a photochromic optical material with a high refractive index of the present invention further includes a photochromic compound along with the compound represented by Formula 1 or 2 and the compound represented by Formula 3. Descriptions of configurations except for the photochromic compound are the same as those of the polymerizable composition for an optical material with a high refractive index.

A photochromic compound is a generally known compound. In particular, inorganic compounds such as silver halide and organic compounds such as spiropyran-based compounds, spiroxazine-based compounds, chromene-based compounds, fulguide-based compounds, azo-based compounds, fulgimide-based compounds, and diarylethene-based compounds are known as photochromic compounds. In the present invention, all known photochromic compounds may be used. Thereamong, a proper compound is selected considering color, etc. As particular examples, Reversacol Platinate Purple (Spiroxazine) (produced by James Robinson), Reversacol Sea Green (Spiropyran) (produced by James Robinson), Reversacol Solar Yellow (Chromene) (produced by James Robinson), Reversacol Berry Red (Spiroxazine) (produced by James Robinson), benzopyran, naphthopyran(naphtho[1,2b], naphtho[2,1-b]), spiro-9-fluoreno[1,2-b]pyran, phenanthropyran, quinoline, indeno-fused naphthopyran, benzoxazine, naphthoxazine, spiro(indoline) pyridobenzoxazine, etc. may be used as the photochromic compound.

In the present invention, the expression “(photochromic) polymerizable composition” is defined as indicating both the polymerizable composition for an optical material with a high refractive index and the polymerizable composition for a photochromic optical material with a high refractive index. In addition, the expression “(photochromic) optical material with a high refractive index” is defined as indicating both the optical material with a high refractive index and the photochromic optical material with a high refractive index.

The fluorine-containing acrylic (photochromic) optical material with a high refractive index of the present invention may be prepared by cast-polymerizing the (photochromic) polymerizable composition. In a preferred embodiment, the purities of all raw materials before cast polymerization are checked. A compound with a low purity is purified, but a compound with a high purity is used without purification. Preferably, a compound having a high purity of 70 to 99.99% is used. In a preferred embodiment, the compound of Formula 1 or 2 and the compound of Formula 3 are mixed and then a reactive catalyst is added thereto, followed by stirring. Subsequently, vacuum degassing is preformed and then the polymerizable composition is injected into a mold. The mold into which the polymerizable composition was injected is inserted into an oven with forced air circulation and heated from 30° C. to 100° C. Subsequently, cooling is performed to 70±10° C. and the mold is detached. As a result, a lens is obtained.

The (photochromic) optical material with a high refractive index obtained according to the present invention may be used in various fields such as prism lenses, prism film coating agents, LED lenses, and vehicle headlights, as well as optical lenses including glass lenses.

### EXAMPLES

Now, the present invention will be described in more detail with reference to the following examples. These examples are provided only for illustration of the present invention and should not be construed as limiting the scope and spirit of the present invention.

Compounds Used in Examples

Compound (I):

A fluorine-based acrylic resin having an average molecular weight of 546 g was used and a structural formula thereof is illustrated below as Formula 11.

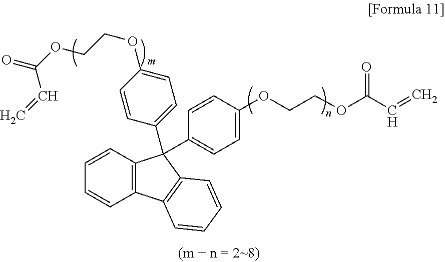

Compound (II):

A fluorine-based acrylic resin having an average molecular weight of 561 g was used and a structural formula thereof is illustrated below as Formula 12.

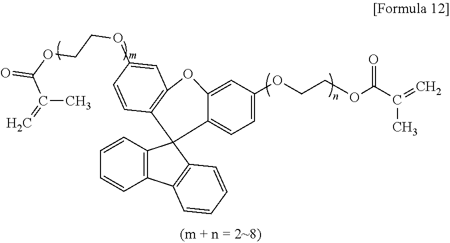

Compound (III):

An ethoxylated o-phenylphenol acrylate resin having an average molecular weight of 269 g was used and a structural formula thereof is illustrated below as Formula 13.

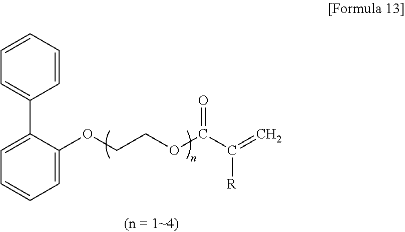

Compound (IV):

Acrylic acid was introduced into polyethyleneglycol having an average molecular weight of 200 g and a compound having an average molecular weight of 308 g was used. A structural formula of the compound is illustrated below as Formula 14.

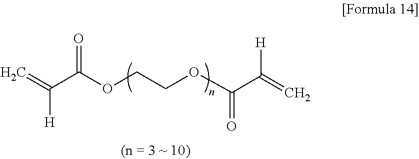

Compound (V)

Alcoholic resin was obtained by adding ethylene oxide to bisphenol A having an average molecular weight of 350 g. A compound having an average molecular weight of 486 g obtained by introducing methacrylic acid into the alcoholic resin was used, and the structural formula of the compound is illustrated below as Formula 15.

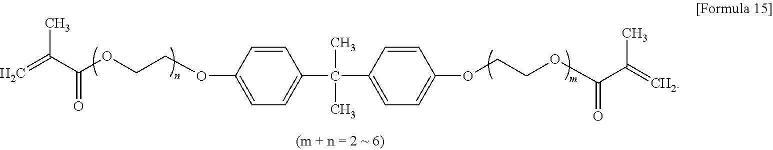

Compound (VI)

2-phenoxyethyl acrylate having a molecular weight of 192.21 g was used and a structural formula thereof is illustrated below as Formula 16.

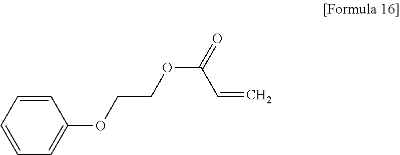

Property Test Methods

Properties of manufactured optical lenses were measured according to the following methods. Results are summarized in Table 1.

1) Refractive index and Abbe number: Measured by means of an Abbe refractometer model DR-M4 manufactured by Atago.

2) Specific gravity: Measured according to an underwater substitution method using an analytical balance.

3) Demolding properties: Upon manufacture of an optical lens, an epoxy acrylic resin composition was thermally hardened. Upon separation of the optical lens from a mold at 70° C., “◯” or “X” was marked depending upon a degree of damage of the lens or the mold. “◯” was marked when, upon separation of 100 optical lenses from molds, the lenses or molds were not destroyed at all, or only one thereof was destroyed. “X” was marked when, upon separation of 100 optical lenses from molds, four or more thereof were destroyed.

4) Transparency: 100 sheets of lenses were observed with the naked eye under an USHIO USH-10D mercury arc lamp. When less than three optical lenses were observed as being turbid, “◯” was marked. When three or more optical lenses were observed as being turbid, “X” was marked.

5) Thermal stability: Hardened optical lenses were maintained at 100° C. for 10 hours and color change thereof was measured. When an APHA change value was less than two, “◯” was marked. When the APHA change value was two or more, “X” was marked.

6) Light resistance: A QUV/SE mold, as an accelerated weathering tester, manufactured by Q-Lab was used. A QUV test was carried out by performing irradiation for eight hours by means of a flat lens with a thickness of 1.2 mm. In particular, conditions of the irradiation are as follows: UVA-340 (340 nm), irradiance of 0.76 W/m², blank panel temperature (BPT, 60° C.) for four hours, and condensation at 50° C. for four hours. Subsequently, color change was measured. When an APHA change value was less than three, “◯” was marked. On the other hand, when an APHA change value was three or more, “X” was marked.

### Example 1

As summarized in Table 1, 10 g of divinylbenzene, as a molecular weight regulator, and 0.5 g of alpha-methylstyrene dimer were added to a mixture of 12 g of Compound I, 48 g of Compound III, 7 g of Compound IV, 16 g of Compound V, and 7 g of Compound VI, followed by stirring for about 30 minutes. Subsequently, filtration was carried out using a filter paper with a pore size of 0.45 μm or less. To this filtered product, 0.3 g of V-65(2,2-azobis(2,4-dimethylpentanenitrile) and 0.03 g of DPC(1,1-di-(tert-butylperoxy)-3,3,5-trimethylcyclohexane), as catalysts, were added, followed by mixing. As a result, a polymerizable composition for a glass lens was prepared. Subsequently, a glass lens was manufactured according to the following methods, and properties of the glass lens were measured. Results are summarized in Table 1.

(1) A prepared polymerizable composition was stirred for one hour and then vacuum degassing was carried out for 10 minutes. A resultant composition was injected into a glass mold assembled using a polyester adhesive tape.

(2) The glass mold into which the polymerizable composition was injected was thermally hardened at 35° C. to 110° C. in an oven with forced air circulation for 20 hours and cooled to 70° C., thereby obtaining a lens. The obtained lens was processed to a diameter of 72 mm and then cleaned with an aqueous alkaline cleaning solution. Subsequently, annealing treatment was carried out at 120° C. for two hours. Properties of a resultant lens were measured according to the following methods. Results are summarized in Table 1.

### Examples 2 to 3

A polymerizable composition for a glass lens and a glass lens were produced using each of compositions summarized in Table 1 according to the method of Example 1 and properties thereof were tested. Results thereof are summarized in Table 1.

### Example 4

As summarized in Table 1, 14 g of divinylbenzene, 0.4 g of alpha-methyl styrene dimer, and 0.03 g of a photochromic coloring agent produced by JAMES ROBINSON were added to 12 g of Compound I, 48 g of Compound III, 8 g of Compound IV, 13 g of Compound V, and 5 g of Compound VI, as fluorene epoxy acrylate-based compounds, followed by stirring for about 30 minutes. Subsequently, filtration was carried out using a filter paper with a pore size of 0.45 μm or less. To this filtered product, 0.3 g of V-65(2,2-azobis(2,4-dimethylpentanenitrile) and 0.03 g of DPC(1,1-di-(tert-butylperoxy)-3,3,5-trimethylcyclohexane), as catalysts, were added, followed by mixing. As a result, a photochromic polymerizable composition for a glass lens was prepared. Subsequently, a photochromic glass lens was manufactured according to the method of Example 1, and properties of the glass lens were measured. Results are summarized in Table 1.

### Examples 5 to 7

A polymerizable composition for a photochromic glass lens and a photochromic glass lens were produced using each of compositions summarized in Table 4 according to the method of Example 4 and properties thereof were tested. Results thereof are summarized in Table 1.

As shown in Table 1 below, it can be confirmed that the glass lenses manufactured according to the present invention suppress imbalanced polymerization and exhibit satisfactory demolding properties, transparency, thermal stability, and light resistance.

TABLE 1

| | | Examples | | | | | | |
|---|---|---|---|---|---|---|---|---|
| Ingredients | | 1 | 2 | 3 | 4 | 5 | 6 | 7 |
| Basic resins (g) | Ingredient I | 12 | | 10 | 12 | | 11 | 11 |
| | (Formula 11) | | | | | | | |
| | Ingredient II | | 11 | | | 10 | | |
| | (Formula 12) | | | | | | | |
| | Ingredient III | 48 | 44 | 38 | 48 | 40 | 44 | 44 |
| | (Formula 13) | | | | | | | |
| | Ingredient IV | 7 | 13 | 15 | 8 | 14 | 10 | 10 |
| | (Formula 14) | | | | | | | |
| | Ingredient V | 16 | 10 | 10 | 13 | 15 | 15 | 17 |
| | (Formula 15) | | | | | | | |
| | Ingredient VI | 7 | 6 | 9 | 5 | 7 | 5 | 5 |
| | (Formula 16) | | | | | | | |
| Polymerization | DVB | 10 | 16 | 18 | 14 | 14 | 15 | 13 |
| regulator | (g) | | | | | | | |
| Photochromic | C1 | | | | 0.03 | | | |
| coloring agent | C2 | | | | | 0.03 | | |
| (g) | C3 | | | | | | 0.03 | |
| | C4 | | | | | | | 0.03 |
| Radical | DPC | 0.03 | 0.03 | 0.03 | 0.03 | 0.03 | 0.03 | 0.03 |
| initiator (g) | | | | | | | | |
| | V65 | 0.3 | 0.3 | 0.3 | 0.3 | 0.3 | 0.3 | 0.3 |
| Optical | Refractive | 1.6053 | 1.5976 | 1.5895 | 1.6015 | 1.5970 | 0.5976 | 1.5988 |
| characteristics | index (nE, | | | | | | | |
| | 20° C.) | | | | | | | |
| | Abbe number | 29.9 | 29.8 | 30.2 | 29.8 | 30.1 | 29.9 | 29.6 |
| | (υd, 20° C.) | | | | | | | |
| | Specific | 1.201 | 1.198 | 1.190 | 1.199 | 1.196 | 1.198 | 1.197 |
| | gravity | | | | | | | |
| | Tg (° C.) | 89 | 93 | 84 | 89 | 90 | 86 | 88 |
| | Releasability | 0 | 0 | 0 | 0 | 0 | 0 | 0 |
| | Thermal | 0 | 0 | 0 | 0 | 0 | 0 | 0 |
| | stability | | | | | | | |
| | Light | 0 | 0 | 0 | 0 | 0 | 0 | 0 |
| | resistance | | | | | | | |

Polymerization regulators
DVB: Divinylbenzene
Photochromic coloring agents
C1: Reversacol Platinate purple (Spiroxazine) (produced by James Robinson)
C2: Reversacol Sea Green (Spiropyran) (produced by James Robinson)
C3: Reversacol Solar Yellow (Chromene) (produced by James Robinson)
C4: Reversacol Berry Red (Spiroxazine) (produced by James Robinson)
Polymerization initiators
V65: 2,2′-azobis(2,4-dimethylvaleronitrile)
DPC: 1,1-di-(tert-butylperoxy)-3,3,5-trimethylcyclohexane

### INDUSTRIAL APPLICABILITY

In accordance with the present invention, a fluorene-containing acrylic optical material that has a high refractive index and superior photochromic performance and optical characteristics can be obtained. A superior fluorene-containing acrylic optical lens according to the present invention has superior photochromic colorability, and satisfactory transparency, thermal stability, and light resistance. Therefore, the fluorene-containing acrylic optical lens of the present invention having a high refractive index, and superior photochromic performance and optical characteristics to existing photochromic lenses with a medium refractive index can be broadly used, instead of existing photochromic optical materials with a high refractive index. In particular, the (photochromic) optical material with a high refractive index of the present invention can be applied to various fields such as a glass lens-including optical lens, prism lens, prism film coating agent, LED lens, and vehicle headlight.

1. A polymerizable composition for an optical material with a high refractive index, comprising:
(a) a compound represented by Formula 1 or 2 below, and
(b) a compound represented by Formula 3 below:

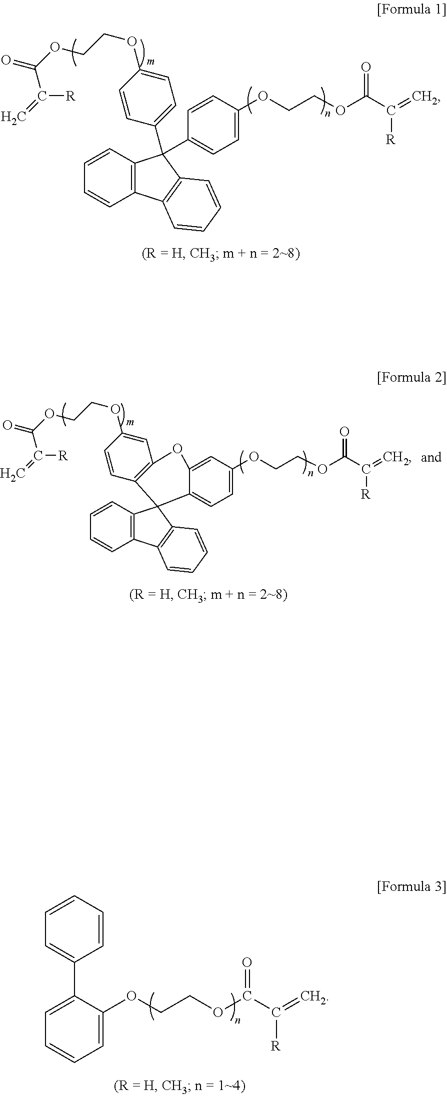

2. The polymerizable composition according to claim 1, comprising 5 to 40% by weight of the compound represented by Formula 1 or 2 and 30 to 60% by weight of the compound represented by Formula 3.

3. The polymerizable composition according to claim 1, comprising 5 to 40% by weight of the compound represented by Formula 1 and 30 to 60% by weight of the compound represented by Formula 3.

4. The polymerizable composition according to claim 1, further comprising one or more compounds selected from the group consisting of a compound represented by Formula 4 below, a compound represented by Formula 5 below, a compound represented by Formula 6 below, diethylene glycol dimethacrylate, triethylene glycol dimethacrylate, tetraethylene glycol dimethacrylate, butanediol dimethacrylate, hexamethylenedimethacrylate, bisphenol A dimethacrylate, 2,2-bis(4-methacryloyloxyethoxy-3,5-dibromophenyl)propane, 2,2-bis-(4-methacryloyloxyethoxy phenyl)propane, 2,2-bis-(4-betaacryloyloxyethoxy phenyl)propane, 2,2-bis-(4-methacryloyloxypentaethoxyphenyl)propane, bis-4-vinyl ether, bis-4-vinyl sulfide, 1,2-(p-vinylbenzyloxy)ethane, 1,2-(p-vinylbenzylthio)ethane, bis-(p-vinylbenzyloxy ethyl)sulfide, 2,2-bis-4-bis-4-vinylbenzyl sulfide, pentaerythritol triacrylate, pentaerythritol tetraacrylate, propoxylated glycerol triacrylate, trimethylolpropane triacrylate, dipentaerythritol hexaacrylate, bisphenol A-diglycidyl ether diacrylate, bisphenol A-diglycidyl ether dimethacrylate, tetrabromo bisphenol A-diglycidyl ether diacrylate, and tetrabromobisphenol A-diglycidyl ether dimethacrylate:

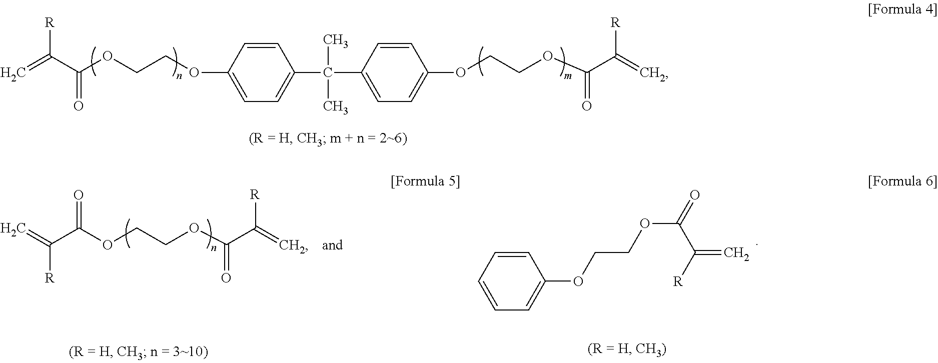

5. The polymerizable composition according to claim 1, further comprising a compound represented by Formula 4 below:

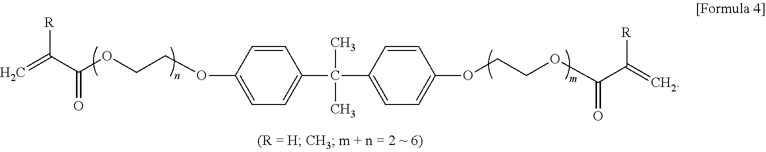

6. The polymerizable composition according to claim 1, further comprising a compound represented by Formula 7 below:

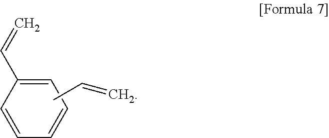

7. The polymerizable composition according to claim 1, further comprising one or more reactive diluents selected from the group consisting of styrene, divinylbenzene, alpha-methylstyrene, alpha-methyl styrene dimer, benzyl methacrylate, chlorostyrene, bromostyrene, methoxystyrene, monobenzyl maleate, dibenzyl maleate, mono-benzyl fumarate, dibenzyl fumarate, methylbenzyl maleate, dimethyl maleate, diethyl maleate, dibutyl maleate, dibutylfumarate, monobutyl maleate, monopentyl maleate, dipentyl maleate, monopentyl fumarate, dipentylfumarate, and diethylene glycol bis-arylcarbonates.

8. The polymerizable composition according to claim 1, further comprising one or more of a thermal stabilizer, an internal release agent, an ultraviolet absorbent, and a polymerization initiator.

9. A polymerizable composition for an optical material with a high refractive index, comprising:
(a) a compound represented by Formula 1 or 2 below,
(b) a compound represented by Formula 3 below, and
(c) a photochromic compound:

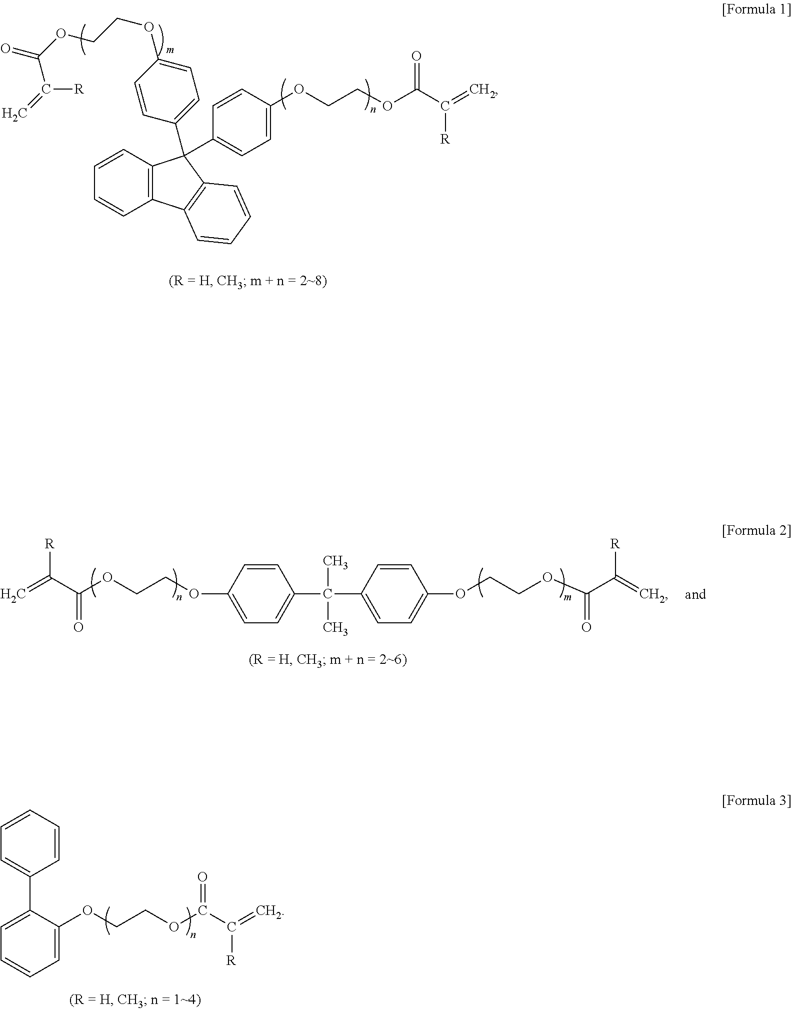

10. The polymerizable composition according to claim 9, comprising 5 to 40% by weight of the compound represented by Formula 1 or 2 and the 30 to 60% by weight of the compound represented by Formula 3.

11. The polymerizable composition according to claim 9, comprising 5 to 40% by weight of the compound represented by Formula 1 and 30 to 60% by weight of the compound represented by Formula 3.

12. The polymerizable composition according to claim 9, further comprising one or more compounds selected from the group consisting of a compound represented by Formula 4 below, a compound represented by Formula 5 below, a compound represented by Formula 6 below, diethylene glycol dimethacrylate, triethylene glycol dimethacrylate, tetraethylene glycol dimethacrylate, butanediol dimethacrylate, hexamethylenedimethacrylate, bisphenol A dimethacrylate, 2,2-bis(4-methacryloyloxyethoxy-3,5-dibromophenyl)propane, 2,2-bis-(4-methacryloyloxyethoxy phenyl)propane, 2,2-bis-(4-betaacryloyloxyethoxy phenyl)propane, 2,2-bis-(4-methacryloyloxypentaethoxyphenyl)propane, bis-4-vinyl ether, bis-4-vinyl sulfide, 1,2-(p-vinylbenzyloxy)ethane, 1,2-(p-vinylbenzylthio)ethane, bis-(p-vinylbenzyloxy ethyl)sulfide, 2,2-bis-4-bis-4-vinylbenzyl sulfide, pentaerythritol triacrylate, pentaerythritol tetraacrylate, propoxylated glycerol triacrylate, trimethylolpropane triacrylate, dipentaerythritol hexaacrylate, bisphenol A-diglycidyl ether diacrylate, bisphenol A-diglycidyl ether dimethacrylate, tetrabromo bisphenol A-diglycidyl ether diacrylate, and tetrabromobisphenol A-diglycidyl ether dimethacrylate:

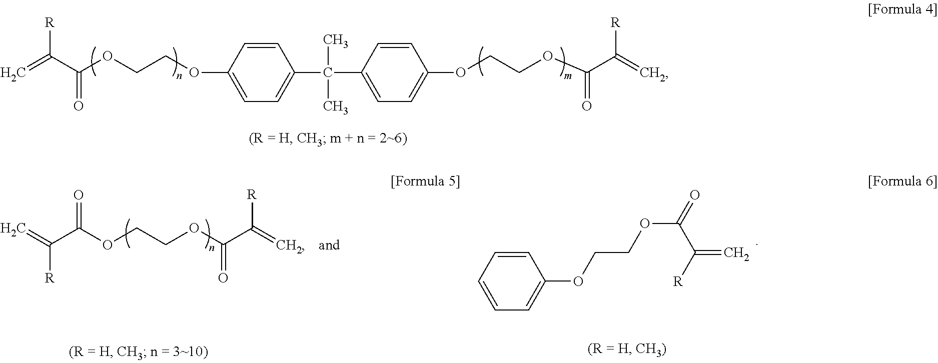

13. The polymerizable composition according to claim 9, further comprising a compound represented by Formula 4 below:

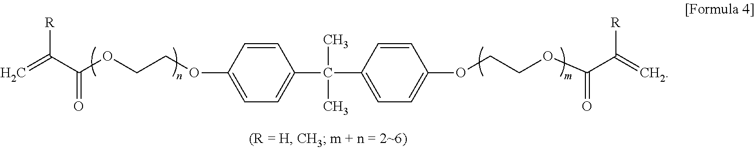

14. The polymerizable composition according to claim 9, further comprising a compound represented by Formula 7 below:

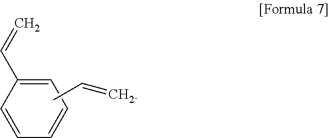

15. The polymerizable composition according to claim 9, further comprising one or more reactive diluents selected from the group consisting of styrene, divinylbenzene, alpha-methylstyrene, alpha-methyl styrene dimer, benzyl methacrylate, chlorostyrene, bromostyrene, methoxystyrene, monobenzyl maleate, dibenzyl maleate, mono-benzyl fumarate, dibenzyl fumarate, methylbenzyl maleate, dimethyl maleate, diethyl maleate, dibutyl maleate, dibutylfumarate, monobutyl maleate, monopentyl maleate, dipentyl maleate, monopentyl fumarate, dipentylfumarate, and diethylene glycol bis-arylcarbonates.

16. The polymerizable composition according to claim 9, further comprising one or more of a thermal stabilizer, an internal release agent, an ultraviolet absorbent, and a polymerization initiator.

17. A method of preparing a fluorene-containing acrylic optical material with a high refractive index, the method comprising cast-polymerizing the polymerizable composition according to claim 1.

18. A fluorene-containing acrylic optical material with a high refractive index obtained by cast-polymerizing the polymerizable composition according to claim 1.

19. The fluorene-containing acrylic optical material according to claim 18, wherein the optical material is an optical lens comprising a glass lens.

20. A method of preparing a fluorine-containing acrylic photochromic optical material with a high refractive index, the method comprising cast-polymerizing the polymerizable composition according to claim 9.

21. A fluorine-containing acrylic photochromic optical material with a high refractive index obtained by cast-polymerizing the polymerizable composition according to claim 9.

22. The fluorine-containing acrylic photochromic optical material according to claim 21, wherein the fluorine-containing acrylic photochromic optical material is an optical lens comprising a glass lens.
